(19) United States
(12) Patent Application Publication
(10) Pub. No.: US 2026/0242589 A1
(43) Pub. Date: Aug. 20, 2026

(54) DYNAMICALLY VULCANIZED COMPOSITIONS COMPRISING ALIPHATIC POLYKETONE, FUNCTIONALIZED RUBBER, AND LOW-ODOR CROSSLINKING COMPOUND

(71) Applicant: AVIENT CORPORATION, Avon Lake, OH (US)

(72) Inventors: Nathan DREGER, Copley, OH (US); Zachary ZANDER, Lake Geneva, WI (US); Robert OPALKO, Middleburgh Heights, OH (US)

(21) Appl. No.: 18/993,103

(22) PCT Filed: Jul. 13, 2023
(86) PCT No.: PCT/US2023/070184

§ 371 Date: Jan. 10, 2025

Related U.S. Application Data
(60) Provisional application No. 63/389,706, filed on Jul. 15, 2022.

(51) Int. Cl. C08L 61/00

(52) U.S. Cl. CPC C08L 61/00; C08L 2205/03; C08L 2205/22; C08L 2312/00

(57) ABSTRACT

Embodiments of the present disclosure are directed to a dynamically vulcanized compositions including the reaction product of, based on a total weight of the dynamically vulcanized composition, about 50 wt % to about 97.5 wt % of an aliphatic polyketone, about 3 wt % to about 50 wt % of a functionalized rubber, and about 0.1 wt % to about 5.0 wt % of a low-odor crosslinking compound.

### CLAIM OF PRIORITY

This application claims the benefit of U.S. Provisional Patent Application Ser. No. 63/389,706 bearing Attorney Docket Number 1202210 and filed on Jul. 15, 2022, which is hereby incorporated by reference in its entirety.

### TECHNICAL FIELD

Embodiments of the present disclosure are generally related to vulcanized compositions, and are specifically related dynamically vulcanized compositions including an aliphatic polyketone, a functionalized rubber, and a low-odor crosslinking compound having improved impact resistance and maintained or improved stiffness.

### BACKGROUND

Thermoplastic vulcanizates may have desirable mechanical properties. However, such conventional thermoplastic vulcanizates may not have the impact resistance and stiffness necessary for certain applications.

Accordingly, a continual need exists for improved vulcanized compositions having improved impact resistance and maintained or improved tensile modulus.

### SUMMARY

Embodiments of the present disclosure are directed to dynamically vulcanized compositions comprising an aliphatic polyketone, a functionalized rubber, and a low-odor crosslinking compound, which have improved impact resistance (i.e., improved Notched Izod impact strength) while providing a maintained or improved stiffness (i.e., maintained or improved tensile modulus).

According to one embodiment, a dynamically thermoplastic vulcanized composition is provided. The dynamically thermoplastic vulcanized composition comprises the reaction product of, based on a total weight of the dynamically vulcanized composition, about 50 wt % to about 97.5 wt % of an aliphatic polyketone; about 3 wt % to about 50 wt % of a functionalized rubber; and about 0.1 wt % to about 5.0 wt % of a low-odor crosslinking compound.

Additional features and advantages of the embodiments described herein will be set forth in the detailed description which follows, and in part will be readily apparent to those skilled in the art from that description or recognized by practicing the embodiments described herein, including the detailed description, which follows and the claims.

### DETAILED DESCRIPTION

Reference will now be made in detail to various embodiments of dynamically vulcanized compositions, specifically, dynamically vulcanized compositions comprising the reaction product of, based on a total weight of the dynamically vulcanized composition, about 50 wt % to about 97.5 wt % of an aliphatic polyketone; about 3 wt % to about 50 wt % of a functionalized rubber; and about 0.1 wt % to about 5.0 wt % of a low-odor crosslinking compound.

The disclosure should not be construed as limited to the embodiments set forth herein. Rather, these embodiments are provided so that this disclosure will be thorough and complete, and will fully convey the subject matter to those skilled in the art.

### Definitions

Unless otherwise defined, all technical and scientific terms used herein have the same meaning as commonly understood by one of ordinary skill in the art. The terminology used in the disclosure herein is for describing particular embodiments only and is not intended to be limiting.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used in the specification and the appended claims, the singular forms “a,” “an,” and “the” are intended to include the plural forms as well, unless the context clearly indicates otherwise. Thus, for example, reference to “a” component includes aspects having two or more such components, unless the context clearly indicates otherwise.

The term “wt %,” as described herein, refers to the weight fraction of the individual reactants of the formulation used to produce the reaction product that comprises the dynamically vulcanized composition, unless otherwise noted. For simplicity purposes, “wt %” will be referred to throughout as the amount based on a total weight of the dynamically vulcanized composition.

The term “Shore D hardness,” as described herein, refers to the hardness of a material as measured according to ASTM D2240.

The term “tensile modulus,” as described herein, refers to the ratio of the stress along an axis over the strain along that axis as measured according to ASTM D638 at 23° C. and a rate of strain of 8.5 mm/s.

The term “Notched Izod Impact strength,” as described herein, refers to the kinetic energy needed to initiate fracture and continue the fracture until an article formed from the polymer blend described herein is broken as measured according to ASTM D256 at 23° C. and 5 J, unless otherwise noted.

The term “melt flow rate,” as described herein, refers to the ability of a material's melt to flow under pressure as measured according to ASTM D1238 at the given temperature and given weight.

The term “specific gravity,” as described herein, refers to the ratio of the density of a material to the density of water as measured according to ASTM D792 at 23° C.

“Glass transition temperature” or “T_{g},” as described herein, is measured according to ASTM D4440.

The terms “improved impact resistance” or “improved Notched Izod strength,” as described herein, refer to a Notched Izod strength that is at least 125% greater than a similar composition that is identical to the dynamically vulcanized composition with the exception that the similar composition does not include a low-odor crosslinking compound.

The terms “maintained or improved stiffness” or “maintained or improved tensile modulus,” as described herein, refer to a tensile modulus that is at least 65% of or is greater than the tensile modulus of a similar composition that is identical to the dynamically vulcanized composition with the exception that the similar composition does not include a low-odor crosslinking compound.

Thermoplastic vulcanizates including aliphatic polyketone may have desirable mechanical properties or may be modified, e.g., with an impact modifier, to achieve such properties. However, conventional impact modifiers used for thermoplastic vulcanizates may not be compatible with aliphatic polyketone. Moreover, the addition of an impact modifier generally decreases the tensile modulus of the composition.

Disclosed herein are dynamically vulcanized compositions, which mitigate the aforementioned problems. Specifically, the dynamically vulcanized compositions disclosed herein comprise the reaction product of, based on a total weight of the dynamically vulcanized composition, about 50 wt % to about 97.5 wt % of an aliphatic polyketone, about 3 wt % to about 50 wt % of a functionalized rubber, and about 0.1 wt % to about 5.0 wt % of a low-odor crosslinking compound, which results in a dynamically vulcanized composition having improved impact resistance (i.e., improved Notched Izod impact strength) while providing a maintained or improved stiffness (i.e., maintained or improved tensile modulus). The inclusion of the low-odor crosslinking compound to crosslink improves the miscibility between the aliphatic polyketone and the functionalized rubber, thereby improving the impact resistance and maintaining or improving the stiffness of the resulting dynamically vulcanized composition.

The dynamically vulcanized composition disclosed herein may generally be described as the reaction product of an aliphatic polyketone, a functionalized rubber, and a low-odor crosslinking compound.

### Aliphatic Polyketone

The dynamically vulcanized composition described herein comprises an aliphatic polyketone. Those skilled in the art will appreciate that aliphatic polyketones include polymers prepared from carbon monoxide and at least one olefin. In embodiments, the molar ratio of carbon monoxide to olefin in the aliphatic polyketone may be in the range of 1.2:1 to 1:1.2, 1.1:1 to 1:1.1, or 1.05:1 to 1:1.05. Suitable olefins for use in an aliphatic polyketone include ethylene and propylene. In embodiments, the aliphatic polyketone is a copolymer of carbon monoxide and ethylene. In embodiments, the aliphatic polyketone is a copolymer of carbon monoxide, ethylene, and a second olefin having at least 3 carbon atoms. In embodiments, the aliphatic polyketone is a copolymer of carbon monoxide, ethylene, and propylene. In some embodiments where the olefin content of the aliphatic polyketone is ethylene and propylene, the weight percent of the total olefin content may be up to 20 wt %, 15 wt %, 10 wt %, or 5 wt % propylene with the balance of the olefin content being ethylene.

Inclusion of aliphatic polyketones may result in improved properties as compared to conventional polyolefin and polyamide thermoplastic vulcanizates. In particular, the aliphatic polyketone has ketone functionalities on every repeat unit of the base polymer which allows for crosslinking at multiple locations along the polymer, leading to improved impact resistance. In contrast, polyamide only couples at the ends of the polymer. In embodiments, the dynamically vulcanized composition may be free of a polyamide polymer.

In embodiments, the aliphatic polyketone may have a melt flow rate (240° C./2.16 kg) greater than or equal to about 3 g/10 min. In embodiments, the aliphatic polyketone may have a melt flow rate (240° C./2.16 kg) less than or equal to about 200 g/10 min. In embodiments, the aliphatic polyketone may have a melt flow rate (240° C./2.16 kg) greater than or equal to about 3 g/10 min, greater than or equal to about 5 g/10 min, greater than or equal to about 10 g/10 min, greater than or equal to about 25 g/10 min, or even greater than or equal to about 50 g/10 min. In embodiments, the aliphatic polyketone may have a melt flow rate (240° C./2.16 kg) less than or equal to about 200 g/10 min, less than or equal to about 150 g/10 min, less than or equal to about 100 g/10 min, less than or equal to about 50 g/10 min, less than or equal to about 25 g/10 min, or even less than or equal to about 10 g/10 min. In embodiments, the aliphatic polyketone may have a melt flow rate (240° C./2.16 kg) from about 3 g/10 min to about 200 g/10 min, from about 3 g/10 min to about 150 g/10 min, from about 3 g/10 min to about 100 g/10 min, from about 3 g/10 min to about 50 g/10 min, from about 3 g/10 min to about 25 g/10 min, from about 3 g/10 min to about 10 g/10 min, from about 5 g/10 min to about 200 g/10 min, from about 5 g/10 min to about 150 g/10 min, from about 5 g/10 min to about 100 g/10 min, from about 5 g/10 min to about 50 g/10 min, from about 5 g/10 min to about 25 g/10 min, from about 5 g/10 min to about 10 g/10 min, from about 10 g/10 min to about 200 g/10 min, from about 10 g/10 min to about 150 g/10 min, from about 10 g/10 min to about 100 g/10 min, from about 10 g/10 min to about 50 g/10 min, from about 10 g/10 min to about 25 g/10 min, from about 25 g/10 min to about 200 g/10 min, from about 25 g/10 min to about 150 g/10 min, from about 25 g/10 min to about 100 g/10 min, from about 25 g/10 min to about 50 g/10 min, from about 50 g/10 min to about 200 g/10 min, from about 50 g/10 min to about 150 g/10 min, or even from about 50 g/10 min to about 100 g/10 min, or any and all subranges formed from any of these endpoints.

In embodiments, the aliphatic polyketone may have a Notched Izod impact strength, measured in accordance to ASTM D256 at 23° C. and 5 J, greater than or equal to about 150 J/m, greater than or equal to about 175 J/m, or even greater than or equal to about 200 J/m. In embodiments, the aliphatic polyketone may have a Notched Izod impact strength, measured in accordance to ASTM D256 at 23° C. and 5 J, less than or equal to about 300 J/m, less than or equal to about 275 J/m, or even less than or equal to about 250 J/m. In embodiments, the aliphatic polyketone may have a Notched Izod impact strength, measured in accordance to ASTM D256 at 23° C. and 5 J, from about 150 J/m to about 300 J/m, from about 150 J/m to about 275 J/m, from about 150 J/m to about 250 J/m, from about 175 J/m to about 300 J/m, from about 175 J/m to about 275 J/m, from about 175 J/m to about 250 J/m, from about 200 J/m to about 300 J/m, from about 200 J/m to about 275 J/m, or even from about 200 J/m to about 250 J/m, or any and all subranges formed from any of these endpoints.

In embodiments, the aliphatic polyketone may have a Notched Izod impact strength, measured in accordance to ASTM D256 at −30° C. and 5 J, greater than or equal to about 25 J/m or even greater than or equal to about 50 J/m. In embodiments, the aliphatic polyketone may have a Notched Izod impact strength, measured in accordance to ASTM D256 at −30° C. and 5 J, less than or equal to about 300 J/m, less than to about 250 J/m, less than or equal to about 200 J/m, less than or equal to about 150 J/m, or even less than or equal to about 100 J/m. In embodiments, the aliphatic polyketone may have a Notched Izod impact strength, measured in accordance to ASTM D256 at −30° C. and 5 J, from about 25 J/m to about 300 J/m, from about 25 J/m to about 250 J/m, from about 25 J/m to about 200 J/m, from about 25 J/m to about 150 J/m, from about 25 J/m to about 100 J/m, from about 50 J/m to about 300 J/m, from about 50 J/m to about 250 J/m, from about 50 J/m to about 200 J/m, from about 50 J/m to about 150 J/m, or even from about 50 J/m to about 100 J/m, or any and all subranges formed from any of these endpoints.

In embodiments, the aliphatic polyketone may have a tensile modulus greater than or equal to about 750 MPa, greater than or equal to about 1000 MPa, or even greater than or equal to about 1250 MPa. In embodiments, the aliphatic polyketone may have a tensile modulus less than or equal to about 2000 MPa, less than or equal to about 1750 MPa, or even less than or equal to about 1500 MPa. In embodiments, the aliphatic polyketone may have a tensile modulus from about 750 MPa to about 2000 MPa, from about 750 MPa to about 1750 MPa, from about 750 MPa to about 1500 MPa, from about 1000 MPa to about 2000 MPa, from about 1000 MPa to about 1750 MPa, from about 1000 MPa to about 1500 MPa, from about 1250 MPa to about 2000 MPa, from about 1250 MPa to about 1750 MPa, or even from about 1250 MPa to about 1500 MPa, or any and all subranges formed from these endpoints.

In embodiments, the aliphatic polyketone may have a specific gravity greater than or equal to about 1.1 or even greater than or equal to about 1.2. In embodiments, the aliphatic polyketone may have a specific gravity less than or equal to about 1.4 or even less than or equal to about 1.3. In embodiments, the aliphatic polyketone may have a specific gravity from about 1.1 to about 1.4, from about 1.1 to about 1.3, from about 1.2 to about 1.4, or even from about 1.2 to about 1.3, or any and all subranges formed from any of these endpoints.

The dynamically vulcanized composition may include at least 50 wt % of an aliphatic polyketone to ensure improved impact resistance and processability. Accordingly, in embodiments, the dynamically vulcanized composition may comprise, based on a total weight of the dynamically vulcanized composition, about 50 wt % to about 97.5 wt % of an aliphatic polyketone. In embodiments, the amount of the aliphatic polyketone in the dynamically vulcanized composition may be, based on a total weight of the dynamically vulcanized composition, greater than or equal to about 50 wt %, greater than or equal to about 55 wt %, greater than or equal to about 60 wt %, greater than or equal to about 65 wt %, greater than or equal to about 70 wt %, greater than or equal to about 75 wt %, greater than or equal to about 80 wt %, or even greater than or equal to about 85 wt %. In embodiments, the amount of the aliphatic polyketone in the dynamically vulcanized composition may be, based on a total weight of the dynamically vulcanized composition, less than or equal to about 97.5 wt %, less than or equal to about 96 wt %, less than or equal to about 95 wt %, less than or equal to about 94 wt %, less than or equal to about 93 wt %, less than or equal to about 92 wt %, less than or equal to about 91 wt %, or even less than or equal to about 90 wt %. In embodiments, the amount of the aliphatic polyketone in the dynamically vulcanized composition may be, based on a total weight of the dynamically vulcanized composition, from about 50 wt % to about 97.5 wt %, from about 50 wt % to about 96 wt %, from about 50 wt % to about 95 wt %, from about 50 wt % to about 94 wt %, from about 50 wt % to about 93 wt %, from about 50 wt % to about 92 wt %, from about 50 wt % to about 91 wt %, from about 50 wt % to about 90 wt %, from about 55 wt % to about 97.5 wt %, from about 55 wt % to about 96 wt %, from about 55 wt % to about 95 wt %, from about 55 wt % to about 94 wt %, from about 55 wt % to about 93 wt %, from about 55 wt % to about 92 wt %, from about 55 wt % to about 91 wt %, from about 55 wt % to about 90 wt %, from about 60 wt % to about 97.5 wt %, from about 60 wt % to about 96 wt %, from about 60 wt % to about 95 wt %, from about 60 wt % to about 94 wt %, from about 60 wt % to about 93 wt %, from about 60 wt % to about 92 wt %, from about 60 wt % to about 91 wt %, from about 60 wt % to about 90 wt %, from about 65 wt % to about 97.5 wt %, from about 65 wt % to about 96 wt %, from about 65 wt % to about 95 wt %, from about 65 wt % to about 94 wt %, from about 65 wt % to about 93 wt %, from about 65 wt % to about 92 wt %, from about 65 wt % to about 91 wt %, from about 65 wt % to about 90 wt %, from about 70 wt % to about 97.5 wt %, from about 70 wt % to about 96 wt %, from about 70 wt % to about 95 wt %, from about 70 wt % to about 94 wt %, from about 70 wt % to about 93 wt %, from about 70 wt % to about 92 wt %, from about 70 wt % to about 91 wt %, from about 70 wt % to about 90 wt %, from about 75 wt % to about 97.5 wt %, from about 75 wt % to about 96 wt %, from about 75 wt % to about 95 wt %, from about 75 wt % to about 94 wt %, from about 75 wt % to about 93 wt %, from about 75 wt % to about 92 wt %, from about 75 wt % to about 91 wt %, from about 75 wt % to about 90 wt %, from about 80 wt % to about 97.5 wt %, from about 80 wt % to about 96 wt %, from about 80 wt % to about 95 wt %, from about 80 wt % to about 94 wt %, from about 80 wt % to about 93 wt %, from about 80 wt % to about 92 wt %, from about 80 wt % to about 91 wt %, from about 80 wt % to about 90 wt %, from about 85 wt % to about 97.5 wt %, from about 85 wt % to about 96 wt %, from about 85 wt % to about 95 wt %, from about 85 wt % to about 94 wt %, from about 85 wt % to about 93 wt %, from about 85 wt % to about 92 wt %, from about 85 wt % to about 91 wt %, or even from about 85 wt % to about 90 wt %, or any and all subranges formed from any of these endpoints.

Suitable commercial embodiments of the aliphatic polyketone are available from Hyosung Corporation, such as grade M630S.

### Functionalized Rubber

The dynamically vulcanized composition described herein comprises a functionalized rubber. In embodiments, the functionalized rubber includes a polymer chain with functional groups located along the polymer chain. The polymer chain of the functionalized rubber may be linear or include one or more branches. A reactive group of the functionalized rubber may react with the low-odor crosslinking compound and crosslink, thereby ensuring improved impact resistance and maintained or improved stiffness.

In embodiments, the functionalized rubber may have a glass transition temperature less than or equal to 23° C. to ensure improved Notched Izod strength as measured according to ASTM D256 at 23° C. and 5 J.

In embodiments, the functionalized rubber may be selected from the group consisting of a functionalized acrylic rubber, methacrylate rubber, acrylic acid rubber, methacrylic acid rubber, acrylonitrile-styrene-acrylate, ethylene propylene diene rubber, ethylene acrylic acid rubber, butadiene rubber, isoprene rubber, styrene-butadiene rubber, styrene-ethylene-butadiene rubber, a functionalized nitrile rubber, or any combination thereof. In embodiments, the functionalized rubber may be hydrogenated.

In embodiments, the functionalized rubber may include a pendant functional group selected from the group consisting of epoxides, sulfur-containing groups, carboxyls, amides, maleic anhydride, maleic acid, alkenes, and alkynes.

The dynamically vulcanized composition may include at least 3 wt % of the functionalized rubber to ensure an improved Notched Izod impact strength is achieved. The amount of functionalized rubber in the dynamically vulcanized composition may be limited (e.g., less than or equal to about 50 wt %) such that the dynamically vulcanized composition may be injection molded. Accordingly, in embodiments, the dynamically vulcanized composition may comprise, based on a total weight of the dynamically vulcanized composition about 3 wt % to about 50 wt % of a functionalized rubber. In embodiments, the amount of the functionalized rubber in the dynamically vulcanized composition may be, based on a total weight of the dynamically vulcanized composition, greater than or equal to about 3 wt %, greater than or equal to about 4 wt %, greater than or equal to about 5 wt %, greater than or equal to about 6 wt %, greater than or equal to about 7 wt %, or even greater than or equal to about 8 wt %. In embodiments, the amount of the functionalized rubber in the dynamically vulcanized composition may be, based on a total weight of the dynamically vulcanized composition, less than or equal to about 50 wt %, less than or equal to about 45 wt %, less than or equal to about 40 wt %, less than or equal to about 35 wt %, less than or equal to about 30 wt %, less than or equal to about 25 wt %, less than or equal to about 20 wt %, or even less than or equal to about 15 wt %. In embodiments, the amount of the functionalized rubber in the dynamically vulcanized composition may be, based on a total weight of the dynamically vulcanized composition, from about 3 wt % to about 50 wt %, from about 3 wt % to about 45 wt %, from about 3 wt % to about 40 wt %, from about 3 wt % to about 35 wt %, from about 3 wt % to about 30 wt %, from about 3 wt % to about 25 wt %, from about 3 wt % to about 20 wt %, from about 3 wt % to about 15 wt %, from about 4 wt % to about 50 wt %, from about 4 wt % to about 45 wt %, from about 4 wt % to about 40 wt %, from about 4 wt % to about 35 wt %, from about 4 wt % to about 30 wt %, from about 4 wt % to about 25 wt %, from about 4 wt % to about 20 wt %, from about 4 wt % to about 15 wt %, from about 5 wt % to about 50 wt %, from about 5 wt % to about 45 wt %, from about 5 wt % to about 40 wt %, from about 5 wt % to about 35 wt %, from about 5 wt % to about 30 wt %, from about 5 wt % to about 25 wt %, from about 5 wt % to about 20 wt %, from about 5 wt % to about 15 wt %, from about 6 wt % to about 50 wt %, from about 6 wt % to about 45 wt %, from about 6 wt % to about 40 wt %, from about 6 wt % to about 35 wt %, from about 6 wt % to about 30 wt %, from about 6 wt % to about 25 wt %, from about 6 wt % to about 20 wt %, from about 6 wt % to about 15 wt %, from about 7 wt % to about 50 wt %, from about 7 wt % to about 45 wt %, from about 7 wt % to about 40 wt %, from about 7 wt % to about 35 wt %, from about 7 wt % to about 30 wt %, from about 7 wt % to about 25 wt %, from about 7 wt % to about 20 wt %, from about 7 wt % to about 15 wt %, from about 8 wt % to about 50 wt %, from about 8 wt % to about 45 wt %, from about 8 wt % to about 40 wt %, from about 8 wt % to about 35 wt %, from about 8 wt % to about 30 wt %, from about 8 wt % to about 25 wt %, from about 8 wt % to about 20 wt %, or even from about 8 wt % to about 15 wt %, or any and all subranges formed from any of these endpoints.

Suitable commercial embodiments of the functionalized rubber are available under the HYTEMP brand from Zeon Corporation, such as functionalized polyacrylate grade AR212 HR.

### Low-Odor Crosslinking Compound

The dynamically vulcanized composition described herein comprises a low-odor crosslinking compound. The low-odor crosslinking compound is capable of reacting with the ketone groups of the aliphatic polyketone and the functional groups of the functionalized rubber. Accordingly, the low-odor crosslinking compound may form crosslinks between aliphatic polyketones, between functionalized rubbers, and between a functional rubber and an aliphatic polyketone. As described herein, the low-odor crosslinking compound improves the miscibility between the aliphatic polyketone and the functionalized rubber, improving the impact resistance and maintaining or improving the stiffness of the resulting dynamically vulcanized composition. Without being bound by theory, the low-odor crosslinking compound may also act as a compatibilizing agent.

Because the dynamically vulcanized compositions described herein result from relatively quick crosslinking (e.g., within an extruder), a low-odor crosslinking compound having a relatively high average molecular weight (e.g., greater than or equal to about 200 g/mol) may be used. A compound having a relatively high average molecular weight may be relatively less volatile at the processing temperatures. In embodiments, the low-odor crosslinking compound may have an average molecular weight greater than or equal to about 200 g/mol, greater than or equal to about 250 g/mol, greater than or equal to about 300 g/mol, greater than or equal to about 350 g/mol, or even greater than or equal to about 400 g/mol. In embodiments, the low-odor crosslinking compound may have an average molecular weight less than or equal to about 1200 g/mol, greater than or equal to about 1100 g/mol, greater than or equal to about 1000 g/mol, greater than or equal to about 900 g/mol, or even greater than or equal to about 800 g/mol. In embodiments, the low-odor crosslinking compound may have an average molecular weight of about 200 g/mol to about 1200 g/mol, of about 250 g/mol to about 1100 g/mol, of about 300 g/mol to about 1000 g/mol, of about 350 g/mol to about 900 g/mol, of about 400 g/mol to about 800 g/mol, or any and all subranges formed from any of these endpoints.

In embodiments, the low-odor crosslinking compound may selected from the group consisting of diamines, triamines, multifunctional amines, diols, triols, multifunctional alcohols, dithiols, thiols, carboxylic acids, zwitterions salts, alkenes, and conjugated dienes.

In embodiments, the low-odor crosslinking compound may be a di-functional crosslinking compound. For example, in embodiments, the low-odor crosslinking compound may be defined by formula (I):

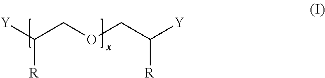

wherein each R may be individually selected from a hydrogen atom or a methyl group, x may be from 4 to 120, and each Y may be individually a functional group selected from the group consisting of amines, alcohols, thiols, carboxylic acids, alkenes, and conjugated dienes. For example, in embodiments, the low-odor crosslinking compound may be defined by formula (II):

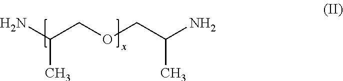

wherein x may be from 4 to 120.

In embodiments in which the low-odor crosslinking compound is defined by formula (I) or formula (II), x may be from 4 to 120, from 4 to 100, from 4 to 80, from 4 to 60, from 4 to 40, from 4 to 20, from 4 to 10, from 5 to 120, from 5 to 100, from 5 to 80, from 5 to 60, from 5 to 40, from 5 to 20, from 5 to 10, from 6 to 120, from 6 to 100, from 6 to 80, from 6 to 60, from 6 to 40, from 6 to 20, or even from 6 to 10, or any and all subranges formed from any of these endpoints.

In embodiments, the low-odor crosslinking compound may be a multi-functional crosslinking compound that includes three or more functional groups. For example, in embodiments, the low-odor crosslinking compound may be defined by formula (III):

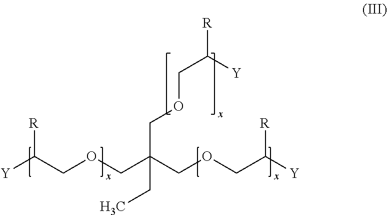

wherein each R may be individually selected from a hydrogen atom or a methyl group, each x may be from 1 to 40, and the total sum of the x units may be from 3 to 120, and each Y may be individually a functional group selected from the group consisting of amines, alcohols, thiols, carboxylic acids, alkenes and conjugated dienes. For example, in embodiments, the low-odor crosslinking compound may be defined by formula (IV):

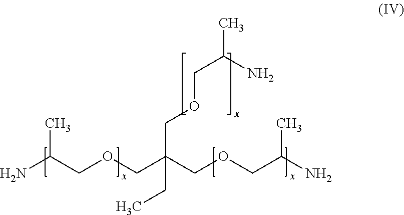

wherein each x may be from 1 to 40, and the total sum of the x units may be from 3 to 120.

In embodiments in which the low-odor crosslinking compound is defined by formula (III) or formula (IV), each x may be from 1 to 40, from 1 to 30, from 1 to 20, from 1 to 10, from 2 to 40, from 2 to 30, from 2 to 20, from 2 to 10, from 4 to 40, from 4 to 30, from 4 to 20, from 4 to 10, from 6 to 40, from 6 to 30, from 6 to 20, or even from 6 to 10, or any and all subranges formed from any of these endpoints. In embodiments in which the low-odor crosslinking compound is defined by formula (III) or formula (IV), the total sum of the x units may be from 3 to 120, from 3 to 90, from 3 to 60, from 3 to 30, from 6 to 120, from 6 to 90, from 6 to 60, from 6 to 30, from 12 to 120, from 12 to 90, from 12 to 60, from 12 to 30, from 18 to 120, from 18 to 90, from 18 to 60, or even from 18 to 30, or any and all subranges formed from any of these endpoints.

In other embodiments in which the low-odor crosslinking compound may be a multi-functional crosslinking compound that includes three or more functional groups, the low-odor crosslinking compound may be defined by formula (V):

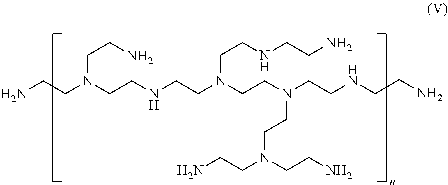

wherein n may be from 1 to 50. In embodiments in which the low-odor crosslinking compound is defined by formula (V), n may be from 1 to 50, from 1 to 40, from 1 to 30, from 1 to 20, from 1 to 10, from 1 to 5, or even from 1 to 3.

The dynamically vulcanized composition may include at least 0.1 wt % of a low-odor crosslinking compound to ensure miscibility between the aliphatic polyketone and the functionalized rubber. The amount of low-odor crosslinking compound may be limited (e.g., less than or equal to about 5 wt %) to ensure that properties of the dynamically vulcanized composition are due to the occurrence of crosslinking of the aliphatic polyketone and/or the functionalized rubber, not because of a relatively large amount of low-odor crosslinking compound. Accordingly, in embodiments, the dynamically vulcanized composition may comprise, based on a total weight of the dynamically vulcanized composition, about 0.1 wt % to about 5 wt % of a low-odor crosslinking compound. In embodiments, the amount of the low-odor crosslinking compound in the dynamically vulcanized composition may be, based on a total weight of the dynamically vulcanized composition, greater than or equal to about 0.1 wt % or even greater than or equal to about 0.25 wt %. In embodiments, the amount of the low-odor crosslinking compound in the dynamically vulcanized composition may be, based on a total weight of the dynamically vulcanized composition, less than or equal to about 5 wt %, less than or equal to about 4 wt %, less than or equal to about 3 wt %, less than or equal to about 2 wt %, less than or equal to about 1 wt %, or even less than or equal to about 0.5 wt %. In embodiments, the amount of the low-odor crosslinking compound in the dynamically vulcanized composition may be, based on a total weight of the dynamically vulcanized composition, from about 0.1 wt % to about 5 wt %, from about 0.1 wt % to about 4 wt %, from about 0.1 wt % to about 3 wt %, from about 0.1 wt % to about 2 wt %, from about 0.1 wt % to about 1 wt %, from about 0.1 wt % to about 0.5 wt %, from about 0.25 wt % to about 5 wt %, from about 0.25 wt % to about 4 wt %, from about 0.25 wt % to about 3 wt %, from about 0.25 wt % to about 2 wt %, from about 0.25 wt % to about 1 wt %, or even from about 0.25 wt % to about 0.5 wt %, or any and all subranges formed from any of these endpoints.

In embodiments, one low-odor crosslinking compound may be employed to prepare a dynamically vulcanized composition. In other embodiments, two or more low-odor crosslinking compound may be employed. For example, two or more low-odor crosslinking compounds selected from formula I, II, III, IV, and V may be employed.

Suitable commercial embodiments of the low-odor crosslinking compound are available under the JEFFAMINE brand from Huntsman, such as polyetheramine grade T-403 or polyetheramine grade D-400.

### Dynamically Vulcanized Composition

As described herein, the inclusion of a low-odor crosslinking compound to crosslink the aliphatic polyketone and the functionalized rubber improved Notched Izod impact strength while providing or improving tensile modulus.

In embodiments, the aliphatic polyketone may form a matrix and the functionalized rubber may form particles that are dispersed in the aliphatic polyketone matrix. In such embodiments, the low-odor crosslinking compound crosslinks the aliphatic polyketone within the matrix of the aliphatic polyketone, the low-odor crosslinking compound crosslinks the functionalized rubber within the particles of the functionalized rubber, and the low-odor crosslinking compound couples the functionalized rubber with the aliphatic polyketone at an interface between the particles of the functionalized rubber and the matrix of the aliphatic polyketone.

In embodiments, when in the form of particles, the functionalized rubber may have a particle size distribution D50, as measured with atomic force microscopy, of less than 20 microns, less than 18 microns, less than 16 microns, less than 14 microns, less than 12 microns, less than 10 microns, less than 8 microns, less than 6 microns, less than 4 microns, less than 2 microns, or less than 1 microns. In embodiments, when in the form of particles, the functionalized rubber may have a particle size distribution D50, as measured with atomic force microscopy, from about 0.01 micron to about 20 microns, from about 0.1 micron to about 18 microns, from about 1 micron to about 16 microns, from about 1 micron to about 14 microns, from about 1 micron to about 12 microns, from about 3 microns to about 20 microns, from about 3 micron to about 18 microns, from about 3 microns to about 16 microns, from about 3 microns to about 14 microns, from about 3 microns to about 12 microns, from about 5 microns to about 20 microns, from about 5 microns to about 18 microns, from about 5 microns to about 16 microns, from about 5 microns to about 14 microns, or even from about 5 microns to about 12 microns, or any and all subranges formed from any of these endpoints.

In embodiments, the dynamically vulcanized composition may have a Notched Izod Impact strength, measured in accordance to ASTM D256 at 23° C. and 5 J, that is greater than a similar composition that is identical to the dynamically vulcanized composition with the exception that the similar composition does not include a low-odor crosslinking compound. In embodiments, the dynamically vulcanized composition may have a Notched Izod Impact strength, measured in accordance to ASTM D256 at 23° C. and 5 J, that is at least 125% greater, at least 150% greater, at least 175% greater, at least 200% greater, at least 225% greater, at least 250% greater, or even at least 275% greater than the similar composition.

In embodiments, the dynamically vulcanized composition may have a Notched Izod Impact strength from about 25 J/m to about 100 J/m, measured in accordance to ASTM D256 at 23° C. and 5 J. In embodiments, the dynamically vulcanized composition may have a Notched Izod Impact strength, measured in accordance to ASTM D256 at 23° C. and 5 J, greater than or equal to about 25 J/m, greater than or equal to about 35 J/m, greater than or equal to about 45 J/m, or even greater than or equal to about 55 J/, In embodiments, the dynamically vulcanized composition may have a Notched Izod Impact strength, measured in accordance to ASTM D256 at 23° C. and 5 J, less than or equal to about 100 J/m, less than or equal to about 90 J/m, less than or equal to about 80 J/m, or even less than or equal to about 70 J/m. In embodiments, the dynamically vulcanized composition may have a Notched Izod Impact strength, measured in accordance to ASTM D256 at 23° C. and 5 J, from about 25 J/m to about 100 J/m, from about 25 J/m to about 90 J/m, from about 25 J/m to about 80 J/m, from about 25 J/m to about 70 J/m, from about 35 J/m to about 100 J/m, from about 35 J/m to about 90 J/m, from about 35 J/m to about 80 J/m, from about 35 J/m to about 70 J/m, from about 45 J/m to about 100 J/m, from about 45 J/m to about 90 J/m, from about 45 J/m to about 80 J/m, from about 45 J/m to about 70 J/m, from about 55 J/m to about 100 J/m, from about 55 J/m to about 90 J/m, from about 55 J/m to about 80 J/m, or even from about 55 J/m to about 70 J/m, or any and all subranges formed from any of these endpoints

In embodiments, the dynamically vulcanized composition may have a tensile modulus, measured in accordance to ASTM D638 at 23° C. and a rate of strain of 8.5 mm/s, that is at least 65%, at least 70%, at least 75%, at least 80%, at least 85%, at least 90%, or even at least 95% of the tensile modulus of a similar composition that is identical to the dynamically vulcanized composition with the exception that the similar composition does not include a low-odor crosslinking compound. In embodiments, the dynamically vulcanized composition has a tensile modulus, measured in accordance to ASTM D638 at 23° C. and a rate of strain of 8.5 mm/s, that is greater than the similar composition. In embodiments, the dynamically vulcanized composition has a tensile modulus, measured in accordance to ASTM D638 at 23° C. and a rate of strain of 8.5 mm/s, that is at least 5% greater, at least 10% greater, at least 15% greater, or even at least 20% greater than the similar composition.

In embodiments, the dynamically vulcanized composition may have a tensile modulus from about 350 MPa to about 2000 MPa, measured in accordance to ASTM D638 at 23° C. and a rate of strain of 8.5 mm/s. In embodiments, the dynamically vulcanized composition may have a tensile modulus, measured in accordance to ASTM D638 at 23° C. and a rate of strain of 8.5 mm/s, greater than or equal to about 350 MPa, greater than or equal to about 500 MPa, greater than or equal to about 650 MPa, or even greater than or equal to about 800 MPa. In embodiments, the dynamically vulcanized composition may have a tensile modulus, measured in accordance to ASTM D638 at 23° C. and a rate of strain of 8.5 mm/s, less than or equal to about 2000 MPa, less than or equal to about 1750 MPa, less than or equal to about 1500 MPa, or even less than or equal to about 1250 MPa. In embodiments, the dynamically vulcanized composition may have a tensile modulus, measured in accordance to ASTM D638 at 23° C. and a rate of strain of 8.5 mm/s, from about 350 MPa to about 2000 MPa, from about 350 MPa to about 1750 MPa, from about 350 MPa to about 1500 MPa, from about 350 MPa to about 1250 MPa, from about 500 MPa to about 2000 MPa, from about 500 MPa to about 1750 MPa, from about 500 MPa to about 1500 MPa, from about 500 MPa to about 1250 MPa, from about 650 MPa to about 2000 MPa, from about 650 MPa to about 1750 MPa, from about 650 MPa to about 1500 MPa, from about 650 MPa to about 1250 MPa, from about 800 MPa to about 2000 MPa, from about 800 MPa to about 1750 MPa, from about 800 MPa to about 1500 MPa, or even from about 800 MPa to about 1250 MPa, or any and all subranges formed from any of these endpoints.

In embodiments, the dynamically vulcanized composition may comprise a Shore D hardness greater than or equal to about 45, greater than or equal to about 55, or even greater than or equal to about 65. In embodiments, the dynamically vulcanized composition may comprise a Shore D hardness less than or equal to about 95, less than or equal to about 85, and less than or equal to about 75. In embodiments, the dynamically vulcanized composition may comprise a Shore D hardness from about 45 to about 95, from about 45 to about 85, from about 45 to about 75, from about 55 to about 95, from about 55 to about 85, from about 55 to about 75, from about 65 to about 95, from about 65 to about 85, or even from about 65 to about 75, or any and all subranges formed from any of these endpoints.

As exemplified in the Examples section below, the dynamically vulcanized compositions described herein comprising the reaction product of an aliphatic polyketone, a functionalized rubber, and a low-odor crosslinking compound having improved impact resistance (i.e., improved Notched Izod impact strength) while providing a maintained or improved stiffness (i.e., maintained or improved tensile modulus).

### Additives

In embodiments, the dynamically vulcanized composition may further comprise an additive. In embodiments, the additive may comprise antioxidants, stabilizers, adhesion promoters; biocides; anti-fogging agents; anti-static agents; blowing and foaming agents; bonding agents and bonding polymers; dispersants; flame retardants and smoke suppressants; mineral fillers; initiators; lubricants; micas; pigments, colorants, and dyes; processing aids; release agents; silanes, titanates, and zirconates; slip and anti-blocking agents; stearates; ultraviolet light absorbers; viscosity regulators; waxes; nanoparticles; or combinations thereof. Suitable nanoparticles include, but are not limited to, nanoclay and graphene. In embodiments, nanoclay may have an aspect ratio range in the range of about 200:1 to about 1000:1. In embodiments, graphene may have an aspect ratio range in the range of about 1000:1 to about 2000:1.

### Processing

In embodiments, the dynamically vulcanized composition described herein may be made with a batch process or continuous process.

In embodiments, the components of the dynamically vulcanized composition, including the aliphatic polyketone, the functionalized rubber, and the low-odor crosslinking compound, may be added to an extruder (27 MM Leistritz Twin Extruder (L/D 60)) and blended. In embodiments, the blending (e.g., in the barrel of the extruder) may be carried out at a temperature in the range of 150° C. to 270° C.

Blending (also known as compounding) devices are well known to those skilled in the art and generally include means of feeding, especially at least one hopper for pulverulent materials and/or at least one injection pump for liquid materials; high-shear blending means, for example a co-rotating or counter-rotating twin-screw extruder, usually comprising a feed screw placed in a heated barrel (or tube); an output head, which gives the extrudate its shape; and means for cooling the extrudate, either by air cooling or by circulation of water. The extrudate is generally in the form of rods continuously exiting the device and able to be cut or formed into granules. However, other forms may be obtained by fitting a die of desired shape on the output die.

### EXAMPLES

Table 1 below shows sources of ingredients used to form Comparative Examples C1 to C5 and Examples E1 to E3.

TABLE 1

| Ingredients | Brand | Source |
|---|---|---|
| aliphatic polyketone | M630S | Hyosung |
| | | Corporation |
| functionalized rubber | HYTEMP AR212HR | Zeon |
| (functionalized polyacrylate) | | Corporation |
| low-odor crosslinking | JEFFAMINE T-403 | Huntsman |
| compound (polyetheramine) | | |
| antioxidant | IRGANOX 1098 | BASF |
| calcium phosphate | EPSOLUTE C13-09 | Budenheim |
| talc-dusting agent | MISTRON VAPOR R | Imerys |

Table 2 below show the formulations (in wt %) used to form and the certain properties of Comparative Examples C1 to C5 and Examples E1 to E3.

TABLE 2

| | C1 | C2 | C3 | C4 | C5 |
|---|---|---|---|---|---|
| M630S | 99.00 | 96.44 | 94.14 | 89.03 | 78.81 |
| HYTEMP AR212HR | 0 | 2.48 | 4.96 | 9.92 | 19.85 |
| JEFFAMINE T-403 | 0.25 | 0.25 | 0 | 0 | 0 |
| IRGANOX 1098 | 0.25 | 0.25 | 0.25 | 0.25 | 0.25 |
| EPSOLUTE C13-09 | 0.50 | 0.50 | 0.50 | 0.50 | 0.50 |
| MISTRON VAPOR R | 0 | 0.08 | 0.15 | 0.30 | 0.59 |
| TOTAL | 100.00 | 100.00 | 100.00 | 100.00 | 100.00 |
| Hardness (Shore D) | 76.5 | 75.8 | 73.7 | 69.9 | 64.5 |
| Tensile modulus (MPa) | 1417.6 | 1336.7 | 1194.4 | 1106.4 | 957.7 |
| Notched Izod impact | 21.4 | 24.5 | 17.9 | 21.8 | 26.8 |
| strength (J/m) | | | | | |

| | E1 | E2 | E3 |
|---|---|---|---|
| M630S | 93.90 | 88.80 | 78.61 |
| HYTEMP AR212HR | 4.95 | 9.90 | 19.80 |
| JEFFAMINE T-403 | 0.25 | 0.25 | 0.25 |
| IRGANOX 1098 | 0.25 | 0.25 | 0.25 |
| EPSOLUTE C13-09 | 0.50 | 0.50 | 0.50 |
| MISTRON VAPOR R | 0.15 | 0.30 | 0.59 |
| TOTAL | 100.00 | 100.00 | 100.00 |
| Hardness (Shore D) | 75.0 | 73.3 | 69.1 |
| Tensile modulus (MPa) | 1274.4 | 1048.3 | 862.9 |
| Tensile modulus relative to C3 (%) | 6.7 | −12.2 | −27.8 |
| Tensile modulus relative to C4 (%) | 15.2 | −5.2 | −22.0 |
| Tensile modulus relative to C5 (%) | 33.1 | 9.5 | −9.9 |
| Notched Izod impact strength (J/m) | 68.5 | 68.9 | 68.9 |
| Notched Izod impact strength | 283.1 | 285.6 | 285.6 |
| relative to C3 (%) | | | |
| Notched Izod impact strength | 213.6 | 215.7 | 215.7 |
| relative to C4 (%) | | | |
| Notched Izod impact strength | 155.8 | 157.5 | 157.5 |
| relative to C5 (%) | | | |

As shown in Table 2, Examples E1 to E3, dynamically vulcanized compositions including an aliphatic polyketone (M630S), greater than or equal to 3 wt % of a functionalized rubber (HYTEMP AR212 HR), and a low-odor crosslinking compound (JEFFAMINE T-403) had a greater Notched Izod impact strength as compared to Comparative Examples C1 and C2, compositions including an aliphatic polyketone, 0 wt % and 2.48 wt %, respectively, of a functionalized rubber, and a low-odor crosslinking compound. As indicated by Comparative Examples C1 and C2 and Examples E1 to E3, using a low-odor crosslinking compound to crosslink aliphatic polyketone and at least 3 wt % functionalized rubber results in a dynamically vulcanized composition having a greater impact resistance as compared to a composition with less than 3 wt % of a functionalized rubber. While not wishing to be bound by theory, improved Notched Izod impact strength may not be observed in a composition with less than 3 wt % of a functionalized rubber because the resulting rubber phase is too small or is not well distributed. Alternatively, less than 3 wt % of a functionalized rubber may result in an insufficient amount of crosslinked rubber, regardless of how well the rubber is dispersed.

Comparative Examples C3 to C5 were of a similar composition that was identical to Examples E1 to E3, respectively, with the exception that Comparative Examples C3 to C5 did not include a low-odor crosslinking compound. As shown in Table 2, Examples E1 to E3 had a Notched Izod impact strength that was at least 125% greater than the Notched Izod impact strength and a tensile modulus that was at least 65% of the tensile modulus Comparative Examples C3 to C5, respectively. As indicated by Comparative Examples C3 to C5 and Examples E1 to E3, using a low-odor crosslinking compound to crosslink aliphatic polyketone and functionalized rubber results in a dynamically vulcanized composition having improved impact resistance while maintaining or improving tensile modulus.

It will be apparent that modifications and variations are possible without departing from the scope of the disclosure defined in the appended claims. More specifically, although some aspects of the present disclosure are identified herein as preferred or particularly advantageous, it is contemplated that the present disclosure is not necessarily limited to these aspects.

1. A dynamically vulcanized composition comprising the reaction product of, based on a total weight of the dynamically vulcanized composition:
about 50 wt % to about 97.5 wt % of an aliphatic polyketone;
about 3 wt % to about 50 wt % of a functionalized rubber; and
about 0.1 wt % to about 5.0 wt % of a low-odor crosslinking compound.

2. The dynamically vulcanized composition of claim 1, wherein the dynamically vulcanized composition comprises, based on a total weight of the dynamically vulcanized composition, about 5 wt % to about 40 wt % of the functionalized rubber.

3. The dynamically vulcanized composition of claim 1, wherein the functionalized rubber has a glass transition temperature less than or equal to 23° C.

4. The dynamically vulcanized composition of claim 1, wherein the functionalized rubber is a functionalized acrylic rubber, methacrylate rubber, acrylic acid rubber, methacrylic acid rubber, acrylonitrile-styrene-acrylate, ethylene propylene diene rubber, ethylene acrylic acid rubber, butadiene rubber, isoprene rubber, styrene-butadiene rubber, styrene-ethylene-butadiene rubber, a functionalized nitrile rubber, or any combination thereof.

5. The dynamically vulcanized composition of claim 1, wherein the functionalized rubber is hydrogenated.

6. The dynamically vulcanized composition of claim 1, wherein the functionalized rubber includes a pendant functional group selected from the group consisting of epoxides, sulfur-containing groups, carboxyls, amides, maleic anhydride, maleic acid, alkenes, and alkynes.

7. The dynamically vulcanized composition of claim 1, wherein the aliphatic polyketone has a melt flow rate in the range of greater than or equal to about 3 g/10 min to less than or equal to about 200 g/10 min, measured in accordance to ASTM D1238 at 240° C. and a weight of 2.16 kg.

8. (canceled)

9. The dynamically vulcanized composition of claim 1, wherein the low-odor crosslinking compound has a molecular weight of greater than or equal to about 200 g/mol.

10. The dynamically vulcanized composition of claim 1, wherein the low-odor crosslinking compound is selected from the group consisting of diamines, triamines, multifunctional amines, diols, triols, multifunctional alcohols, dithiols, thiols, carboxylic acids, zwitterions salts, alkenes, and conjugated dienes.

11. The dynamically vulcanized composition of claim 1, wherein the low-odor crosslinking compound is a di-functional crosslinking compound.

12. The dynamically vulcanized composition of claim 11, wherein the low-odor crosslinking compound is defined by one or more of formula (I): 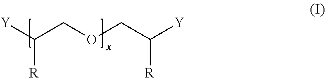
wherein each R is individually selected from a hydrogen atom or a methyl group, x is from 4 to 120, and each Y is individually a functional group selected from the group consisting of amines, alcohols, thiols, carboxylic acids, alkenes, and conjugated dienes;
formula (II): 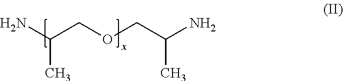
wherein x is from 4 to 120;
formula (III): 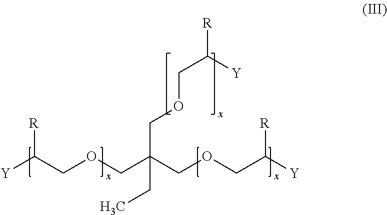
wherein each R is individually selected from a hydrogen atom or a methyl group, each x is from 1 to 40, and the total sum of the x units is from 3 to 120, and each Y is individually a functional group selected from the group consisting of amines, alcohols, thiols, carboxylic acids, alkenes, and conjugated dienes;
formula (IV): 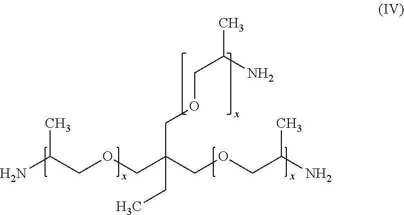
wherein each x is from 1 to 40, and the total sum of the x units is from 3 to 120; or
formula (V): 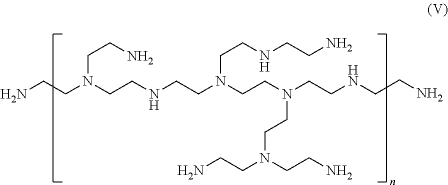
wherein n is from 1 to 50.

13.-17. (canceled)

18. The dynamically vulcanized composition of claim 1, wherein the aliphatic polyketone forms a matrix and the functionalized rubber forms particles that are dispersed in the aliphatic polyketone matrix; and wherein the particles of the functionalized rubber have a particle size distribution D50 from about 1 micron to about 20 microns.

19. (canceled)

20. The dynamically vulcanized composition of claim 18, wherein:
the low-odor crosslinking compound crosslinks the aliphatic polyketone within the matrix of the aliphatic polyketone;
the low-odor crosslinking compound crosslinks the functionalized rubber within the particles of the functionalized rubber; and
the low-odor crosslinking compound couples the functionalized rubber with the aliphatic polyketone at an interface between the particles of the functionalized rubber and the matrix of the aliphatic polyketone.

21. The dynamically vulcanized composition of claim 1, wherein dynamically vulcanized composition is free of a polyamide polymer.

22. The dynamically vulcanized composition of claim 1, wherein the dynamically vulcanized composition has a Notched Izod Impact strength, measured in accordance to ASTM D256 at 23° C. and 5 J, that is greater than a similar composition that is identical to the dynamically vulcanized composition with the exception that the similar composition does not include a low-odor crosslinking compound.

23. (canceled)

24. The dynamically vulcanized composition of claim 1, wherein the dynamically vulcanized composition has a Notched Izod Impact strength from about 25 J/m to about 100 J/m, measured in accordance to ASTM D256 at 23° C. and 5 J.

25. The dynamically vulcanized composition of claim 1, wherein the dynamically vulcanized composition has a tensile modulus, measured in accordance to ASTM D638 at 23° C. and a rate of strain of 8.5 mm/s, that is at least 65% of the tensile modulus of a similar composition that is identical to the dynamically vulcanized composition with the exception that the similar composition does not include a low-odor crosslinking compound.

26. The dynamically vulcanized composition of claim 25, wherein the dynamically vulcanized composition has a tensile modulus, measured in accordance to ASTM D638 at 23° C. and a rate of strain of 8.5 mm/s, that is greater than the similar composition.

27. (canceled)

28. The dynamically vulcanized composition of claim 1, wherein the dynamically vulcanized composition has a tensile modulus from about 350 MPa to about 2000 MPa, measured in accordance to ASTM D638 at 23° C. and a rate of strain of 8.5 mm/s.

29. A dynamically vulcanized composition comprising the reaction product of:
an aliphatic polyketone,
a functionalized rubber, and
a low-odor crosslinking compound;
wherein the dynamically vulcanized composition has a tensile modulus, measured in accordance to ASTM D638 at 23° C. and a rate of strain of 8.5 mm/s, that is at least 65% of the tensile modulus of a similar composition, and
a Notched Izod Impact strength, measured in accordance to ASTM D256 at 23° C. and 5 J, that is at least 125% greater than the similar composition;
wherein the similar composition is identical to the dynamically vulcanized composition with the exception that the similar composition does not include a low-odor crosslinking compound.
